(19) United States
(12) Patent Application Publication
(10) Pub. No.: US 2025/0065510 A1
(43) Pub. Date: Feb. 27, 2025

(54) HUMAN AND ROBOTIC COLLABORATION ASSOCIATED WITH ACTIVITIES

(71) Applicant: International Business Machines Corporation, Armonk, NY (US)

(72) Inventors: Mauro Marzorati, Lutz, FL (US); Carolina Garcia Delgado, Zapopan (MX); Jeremy R. Fox, Georgetown, TX (US); Sarbajit K. Rakshit, Kolkata (IN)

(21) Appl. No.: 18/452,598

(22) Filed: Aug. 21, 2023

(51) Int. Cl. B25J 13/00; G05B 19/4155

(52) U.S. Cl. CPC B25J 13/00; G05B 19/4155; G05B 2219/40202; G06F 3/015

(57) ABSTRACT

An approach for managing activities of users and robotic counterpart of the users is disclosed. The approach includes, receiving data from the users; analyzing the data from the users; determining activities of the users and the robotic counterpart of the users; analyzing a digital twin simulation of based on the activities of the users and robotic counterpart; collecting a first historical data of the activities of the users and the robotic counterpart and a second historical data from the digital twin simulation comparing the brain data against the digital twin simulation by evaluating work criteria; determining whether the data exceeds a predetermined threshold of the work criteria; in responsive to the brain data exceeds the predetermined threshold, generating one or more solutions in order to improve the work criteria of the users and/or the robotic counterpart; and executing the one or more solutions.

### BACKGROUND

The present invention relates generally to human and robotic performing various tasks and activities and more particularly to leveraging a brain-computer interface and machine learning.

A brain-computer interface (BCI), also known as a brain-machine interface (BMI) or “smartbrain,” is a system that allows direct communication between the brain's electrical activity and an external computerized device. Typically, this has been utilized with patients with missing body parts (e.g., legs, arms, hands, etc.) to allow them to walk (i.e., robotic legs) and/or open and close doors (via robotic arms/hands).

Within any industrial space there may be human and robotic collaboration(s) for various activities that need to be performed. Both human intelligent and skills of robotic system with repetitive activities and mechanical strength the effectiveness of any activity can be increased and perfected. In some areas, human can perform the activity in a better way (with amelioration over time). In other areas, robotic systems may outperform their human counterparts.

### SUMMARY

Aspects of the present invention disclose a computer-implemented method, a computer system and computer program product for managing activities of users and robotic counterpart of the users. The computer implemented method may be implemented by one or more computer processors and may include: receiving data from the users; analyzing the brain data from the users; determining activities of the users and the robotic counterpart of the users; analyzing a digital twin simulation of based on the activities of the users and robotic counterpart; collecting a first historical data of the activities of the users and the robotic counterpart and a second historical data from the digital twin simulation; comparing the data against the digital twin simulation by evaluating work criteria, wherein work criteria includes efficiency, safety, quality and cost; determining whether the data exceeds a predetermined threshold of the work criteria; in responsive to the data exceeds the predetermined threshold, generating one or more solutions in order to improve the work criteria of the users and/or the robotic counterpart; and executing the one or more solutions with new instructions to the user and/or the robotic counterpart.

According to another embodiment of the present invention, there is provided a computer system. The computer system comprises a processing unit; and a memory coupled to the processing unit and storing instructions thereon. The instructions, when executed by the processing unit, perform acts of the method according to the embodiment of the present invention.

According to a yet further embodiment of the present invention, there is provided a computer program product being tangibly stored on a non-transient machine-readable medium and comprising machine-executable instructions. The instructions, when executed on a device, cause the device to perform acts of the method according to the embodiment of the present invention.

### BRIEF DESCRIPTION OF THE DRAWINGS

Preferred embodiments of the present invention will now be described, by way of example only, with reference to the following drawings, in which:

FIG. 1 is a diagram illustrating a high level overview of the functionality of the system, designated as activity environment 100, in accordance with an embodiment of the present invention;

FIG. 2 is a diagram illustrating BCI between a human and robot, designated as 200, in accordance with an embodiment of the present invention;

FIG. 3 is a diagram illustrating skin response interface between a human and robot, designated as 300, in accordance with an embodiment of the present invention;

FIG. 4 is a high-level flowchart illustrating the operation of activity component 111, designated as 400, in accordance with an embodiment of the present invention; and

FIG. 5 depicts a block diagram, designated as 500 of components of a server computer capable of executing the activity component 111 within activity environment 100, in accordance with an embodiment of the present invention.

### DETAILED DESCRIPTION

A computer-implemented method for managing activities of users and robotic counterpart of the users. The computer receives data from the users and analyzes the data from the users. The computer determines activities of the users and the robotic counterpart of the users and analyzes a digital twin simulation of based on the activities of the users and robotic counterpart. The computer collects a first historical data of the activities of the users and the robotic counterpart and a second historical data from the digital twin simulation and compares the data against the digital twin simulation by evaluating work criteria. The computer determines whether the data exceeds a predetermined threshold of the work criteria. In responsive to the data exceeds the predetermined threshold, the computer generates one or more solutions in order to improve the work criteria of the users and/or the robotic counterpart. The computer executes the one or more solutions with new instructions to the user and/or the robotic counterpart. As a result, illustrative embodiments provide a technical effect of managing activities of users and robotic counterpart of the users.

The data analyzed by the computer is physiological data from the user consisting of brain waves and/or skin response. The computer determines one or more skillsets and capabilities of the users and robotic counterpart to perform the activities based on the physiological data. The computer assigns new activities based on the one or more skillsets and capabilities to the users and robotic counterpart of the users and aggregates the one or more skillsets and capabilities of the user and the robotic counterpart of the users. The computer communicates to the users via augmented reality (AR) device. As a result, illustrative embodiments provide a technical effect of managing activities of users and robotic counterpart of the users.

Furthermore, the computer in the digital twin simulation comprises of: i) predicting whether the users can complete the activities based on a required quality criteria, ii) predicting whether the users can complete the activities based on the required quality criteria, iii) predicting whether robotic counterpart should assist the user to complete the activities (of the user), iv) organizing and/or tracking the one or more skillsets and capabilities of the users, v) reassigning users to another activity that is better suited based on the one or more skillsets and capabilities of the users, and vi) determining whether to combine both the users and the robotic counterpart to complete the activities (current). The computer in the predetermined threshold is user configurable. As a result, illustrative embodiments provide a technical effect of managing activities of users and robotic counterpart of the users.

In addition, the computer in comparing the data against the digital twin simulation based on the work criteria wherein work criteria includes efficiency, quality, and cost, further comprising: determining whether the users can complete the activities within an allotted timeframe; determining whether the users can complete the activities within an allotted cost; and determining whether the users can complete the activities without sacrificing quality and safety. As a result, illustrative embodiments provide a technical effect of managing activities of users and robotic counterpart of the users.

Moreover, the computer in the one or more solutions further comprises: i) validates if an aggregated skills and capabilities from the one or more skills and capabilities can be used for completing the activities, ii) determines that the aggregated capabilities and capabilities will not be possible to complete the activities, then determines reallocation of the activities, iii) identifies which steps of the activities of the users are to be reallocated to the robotic counterpart, and iv) identifies the activities to be allocated to any existing robotic counterpart or any new robotic counterpart can be allocated to perform the activities. As a result, illustrative embodiments provide a technical effect of managing activities of users and robotic counterpart of the users.

A computer system for managing activities of users and robotic counterpart of the users. The computer system receives data from the users and analyzes the data from the users. The computer system determines activities of the users and the robotic counterpart of the users and analyzes a digital twin simulation of based on the activities of the users and robotic counterpart. The computer system collects a first historical data of the activities of the users and the robotic counterpart and a second historical data from the digital twin simulation and compares the data against the digital twin simulation by evaluating work criteria. The computer system determines whether the data exceeds a predetermined threshold of the work criteria. In responsive to the data exceeds the predetermined threshold, the computer system generates one or more solutions in order to improve the work criteria of the users and/or the robotic counterpart. The computer system executes the one or more solutions with new instructions to the user and/or the robotic counterpart. As a result, illustrative embodiments provide a technical effect of managing activities of users and robotic counterpart of the users.

The data analyzed by the computer system is physiological data from the user consisting of brain waves and/or skin response. The computer system determines one or more skillsets and capabilities of the users and robotic counterpart to perform the activities based on the physiological data. The computer system assigns new activities based on the one or more skillsets and capabilities to the users and robotic counterpart of the users and aggregates the one or more skillsets and capabilities of the user and the robotic counterpart of the users. The computer system communicates to the users via augmented reality (AR) device. As a result, illustrative embodiments provide a technical effect of managing activities of users and robotic counterpart of the users.

Furthermore, the computer system in the digital twin simulation comprises of: i) predicting whether the users can complete the activities based on a required quality criteria, ii) predicting whether the users can complete the activities based on the required quality criteria, iii) predicting whether robotic counterpart should assist the user to complete the activities (of the user), iv) organizing and/or tracking the one or more skillsets and capabilities of the users, v) reassigning users to another activity that is better suited based on the one or more skillsets and capabilities of the users, and vi) determining whether to combine both the users and the robotic counterpart to complete the activities (current). The computer system in the predetermined threshold is user configurable. As a result, illustrative embodiments provide a technical effect of managing activities of users and robotic counterpart of the users.

In addition, the computer system in comparing the data against the digital twin simulation based on the work criteria wherein work criteria includes efficiency, quality, and cost, further comprising: determining whether the users can complete the activities within an allotted timeframe; determining whether the users can complete the activities within an allotted cost; and determining whether the users can complete the activities without sacrificing quality and safety. As a result, illustrative embodiments provide a technical effect of managing activities of users and robotic counterpart of the users.

Moreover, the computer system in the one or more solutions further comprises: i) validates if an aggregated skills and capabilities from the one or more skills and capabilities can be used for completing the activities, ii) determines that the aggregated capabilities and capabilities will not be possible to complete the activities, then determines reallocation of the activities, iii) identifies which steps of the activities of the users are to be reallocated to the robotic counterpart, and iv) identifies the activities to be allocated to any existing robotic counterpart or any new robotic counterpart can be allocated to perform the activities. As a result, illustrative embodiments provide a technical effect of managing activities of users and robotic counterpart of the users.

A computer program product for managing activities of users and robotic counterpart of the users comprises a computer-readable storage medium having program instructions embodied therewith, the program instructions executable by a computer. The computer receives data from the users and analyzes the data from the users. The computer determines activities of the users and the robotic counterpart of the users and analyzes a digital twin simulation of based on the activities of the users and robotic counterpart. The computer collects a first historical data of the activities of the users and the robotic counterpart and a second historical data from the digital twin simulation and compares the data against the digital twin simulation by evaluating work criteria. The computer determines whether the data exceeds a predetermined threshold of the work criteria. In responsive to the data exceeds the predetermined threshold, the computer generates one or more solutions in order to improve the work criteria of the users and/or the robotic counterpart. The computer executes the one or more solutions with new instructions to the user and/or the robotic counterpart. As a result, illustrative embodiments provide a technical effect of managing activities of users and robotic counterpart of the users.

The data analyzed by the computer is physiological data from the user consisting of brain waves and/or skin response. The computer determines one or more skillsets and capabilities of the users and robotic counterpart to perform the activities based on the physiological data. The computer assigns new activities based on the one or more skillsets and capabilities to the users and robotic counterpart of the users and aggregates the one or more skillsets and capabilities of the user and the robotic counterpart of the users. The computer communicates to the users via augmented reality (AR) device. As a result, illustrative embodiments provide a technical effect of managing activities of users and robotic counterpart of the users.

Furthermore, the computer in the digital twin simulation comprises of: i) predicting whether the users can complete the activities based on a required quality criteria, ii) predicting whether the users can complete the activities based on the required quality criteria, iii) predicting whether robotic counterpart should assist the user to complete the activities (of the user), iv) organizing and/or tracking the one or more skillsets and capabilities of the users, v) reassigning users to another activity that is better suited based on the one or more skillsets and capabilities of the users, and vi) determining whether to combine both the users and the robotic counterpart to complete the activities (current). The computer in the predetermined threshold is user configurable. As a result, illustrative embodiments provide a technical effect of managing activities of users and robotic counterpart of the users.

In addition, the computer in comparing the data against the digital twin simulation based on the work criteria wherein work criteria includes efficiency, quality, and cost, further comprising: determining whether the users can complete the activities within an allotted timeframe; determining whether the users can complete the activities within an allotted cost; and determining whether the users can complete the activities without sacrificing quality and safety. As a result, illustrative embodiments provide a technical effect of managing activities of users and robotic counterpart of the users.

Moreover, the computer in the one or more solutions further comprises: i) validates if an aggregated skills and capabilities from the one or more skills and capabilities can be used for completing the activities, ii) determines that the aggregated capabilities and capabilities will not be possible to complete the activities, then determines reallocation of the activities, iii) identifies which steps of the activities of the users are to be reallocated to the robotic counterpart, and iv) identifies the activities to be allocated to any existing robotic counterpart or any new robotic counterpart can be allocated to perform the activities. As a result, illustrative embodiments provide a technical effect of managing activities of users and robotic counterpart of the users.

In any industrial space there may be human and robotic collaboration(s) for various activities that need to be performed. Both human intelligent and skills of robotic system with repetitive activities and mechanical strength the effectiveness of any activity can be increased and perfected. In some areas, human can perform the activity in a better way (with amelioration over time). In other areas, robotic systems may outperform their human counterparts.

Thus, there is a need for monitoring, performing quality control on work performed by and/or between human and robotic workers in an environment by leveraging a “smartbrain” system. For example, one embodiment, executed by one or more processors, can analyze brain signals of the workers and validate if any activity can be executed by human worker and robotic worker. In another embodiment, embodiment is able to track the historical data of the human and validate if the worker can complete the activity with the proper level of quality. In yet another embodiment, embodiment is able to predict in which activities the robot needs to increase the support to the human workers.

The advantages provided by the current embodiment can include, but is not limited to, improvements to timely completion of tasks/activities, precision of work product, quality of work product and less risk of safety issues.

Other embodiments of the present invention may recognize one or more of the following facts, potential problems, potential scenarios, and/or potential areas for improvement with respect to the current state of the art: i) a better prediction of brain signals can yield quality tracking between humans and robots; ii) human and robotic capabilities (and/or skillset) can be relied on to execute a particular activity with a high level of confidence; iii) an increase or decrease of human interaction with the BCI (Brain Computer Interface); and iv) improved skills required for task monitoring (between human vs. robot).

### DEFINITIONS

A brain-computer interface (BCI), also known as a brain-machine interface (BMI) or “smartbrain” is a system that allows direct communication between the brain's electrical activity and an external computerized device. Typically, this has been utilized with patients with missing body parts (e.g., legs, arms, hands, etc.) to allow them to walk (i.e., robotic legs) and/or open and close doors (via robotic arms/hands).

Human workers are typically humans employed (either paid or non-paid) to perform certain tasks in a commercial setting. However, human workers can also perform other tasks in a non-commercial setting, such as, sports and/or other leisure activities.

Tele-robots or robots are robotic machines that can perform various tasks independently or as controlled by a remote pilot.

GVR or “galvanic skin response” is measurement of skin conductance. In the present embodiment, GVR consists of a system that includes one or more sensors to detect physiological changes to the skin based on various emotional states of a human body. The sensors can transmit information related to the skin to a processor that can determine and/or decipher the emotion and/or physiological state of the human. Additionally, EDA (electrodermal activity) will be included under the GVR terminology.

Smart contract rules are rules defined by the user and/or administrator for the embodiment. These rules utilized smart contract programs from blockchain technology. Smart contracts are programs stored on blockchain that rune when a predetermined conditions are met (i.e., IF THEN statements in programming).

BMI decoder is a system that applies a transform algorithm to neuronal inputs to calculate output variables. BMI decoder uses feature extraction and classification to employ a variety of statistical and machine learning.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

It should be understood that the Figures are merely schematic and are not drawn to scale. It should also be understood that the same reference numerals are used throughout the Figures to indicate the same or similar parts.

### High Level Environment Overview

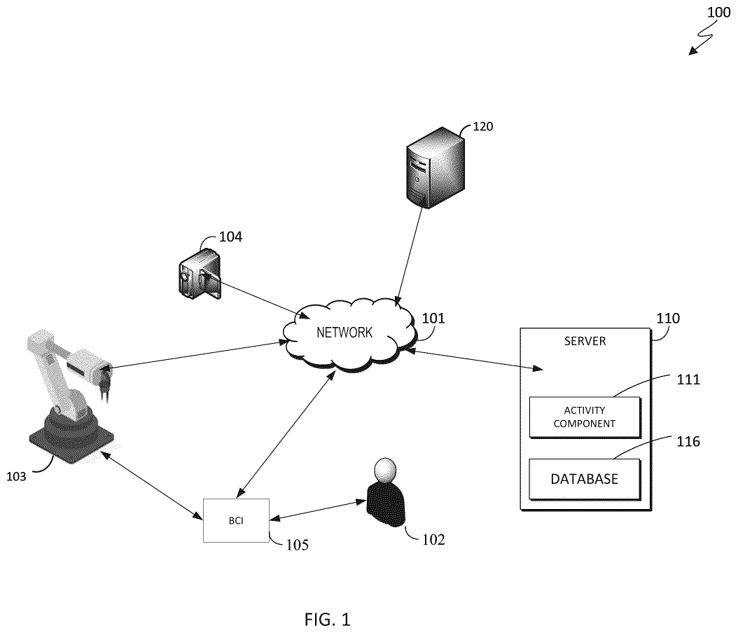

FIG. 1 is a diagram illustrating a high-level overview of the functionality of the system, designated as activity environment 100, in accordance with an embodiment of the present invention.

Activity environment 100 includes network 101, human workers 102, robotic workers 103, IoT devices 104, BCI 105, server 110 and digital twin server 120.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between server 110, digital twin server 120 and other computing devices (not shown) within activity environment 100. It is noted that other computing devices can include, but is not limited to, IoT devices 104, BCI 105 and any electromechanical devices capable of carrying out a series of computing instructions.

Human workers 102 are human “workers” employed to perform various tasks and/or activities. The task and/or activities can include work related to production facilities, infrastructure maintenance and non-commercial setting (e.g., leisure, sports, etc.). In other embodiments, certain animals may be used to perform various tasks instead of human workers. For example, dolphins may be trained to perform search and rescue or mine detection (military related).

Robotic workers 103 are computerized and mechanized equipment that can perform various tasks and activities. They can perform the same task and activities as their human worker counterparts.

IoT devices 104 are smart device that are capable of receiving information and transmitting information. The received information can be associated with data from one or more sensors (e.g., thermal sensors/imaging, proximity sensors, distance measurement (i.e., laser range guide) or object identification/detection cameras and microphones, etc.) that can detect real time sensory information/data.

BCI 105 is a computerized device capable of interfacing with a human brain (including various portions of the nervous system) and an external computerized device. Interface to humans can be invasive, partially invasive or non-invasive, depending on the requirement. Non-invasive interfaces can include the use of EEG (electroencephalogram) technology. In other embodiments, BCI 105 can also interface with the nervous system of other animals and external computerized devices.

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any other programmable electronic device capable of communicating with other computing devices (not shown) within activity environment 100 via network 101. In another embodiment, server 110 represents a computing system utilizing clustered computers and components (e.g., database server computers, application server computers, etc.) that act as a single pool of seamless resources when accessed within activity environment 100.

Digital twin server 120 is a computer server that houses digital twin computing application. Digital twin computing leverages IoT, artificial intelligence (i.e., leveraging machine/deep learning) and software analytics to create living digital simulation models that update and change as their physical counterpart's change. A digital twin continuously learns and updates itself to represent its near real-time status. A digital twin also integrates historical data from past usage to factor into its digital model. What is a simulation? A simulation is an approximation of a process and/or a system (e.g., machines, etc.). Furthermore, simulations are run in virtual environments that may be representations of physical environments but do not integrate real-time data (i.e., used by digital twin computing). The main difference between a simulation (and/or modeling) versus a digital twin is that a digital twin can use real-time data based on the regular transfer of information between the digital twin and its corresponding physical environment.

What simulations and scenarios can be performed by digital twin simulation? While, this is not an exhaustive list, but here are some examples, i) identify the skills, capabilities etc. of human and/or robotic workers, ii) predicting whether the users can complete the activities based on the required quality criteria, iii) predicting whether the users can complete the activities based on the quality criteria, iv) predicting whether robotic counterpart should assist the user to complete the activities (of the user), v) organizing and/or tracking the one or more skillsets and capabilities of the users, vi) reassigning users to another activity that is better suited based on the one or more skillsets and capabilities of the users, vii) determining whether to combine both the users and the robotic counterpart to complete the activities, viii) predicting confidence level of human worker, ix) predicting robotic participation, x) identifying assignment between human and robotic worker, xi) identifying work team size and allocation and xii) determining optimal reallocation and rescheduling activities.

Embodiment of the present invention can reside on server 110 or in a cloud computing environment. Server 110 includes activity component 111 and database 116.

Activity component 111 provides the following capability, but it is not limited to, i) predicting quality output of human and robot, ii) predicting confidence level of human worker, iii) predicting robotic participation, iv) identifying assignment between human and robotic worker, v) identifying work team size and allocation and vi) determining optimal reallocation and rescheduling activities. The six core capabilities will be explained in greater details below.

### Predicting Quality Output of Human and Robot

While both human and robotic workers are working together in any industrial floor, an embodiment of the proposed system can analyze the brain signals of the workers related to the current activity. The result of the analysis can help to predict if the current activity allocation between human worker and robotic worker can complete the activity with the required quality. Furthermore, the analysis can determine if any part of human worker's allocated activity is to be reassigned to robotic worker based on the required quality of the activity.

### Predicting Confidence Level of Human Work

While perform any activity in any industrial floor, an embodiment of the proposed system can use historical knowledge corpus and the brain wave of the workers to predict if the confidence of the human worker to complete the activity (with the desired quality level). However, if the desired quality will not be met then embodiment of the present invention can proactively allocate appropriate robotic resource along with the human worker to complete the activity in a proper manner.

### Predicting Robotic Participation

Based on historical learning about various activities, quality of the activity, an embodiment of the proposed system can predict on where and when robotic participations are to be increased to support the human workers. Accordingly, an embodiment of the proposed system can recommend the activities where workers need to wear Brain Computer Interface (BCI) system.

Additionally, the recommendation module (within activity component 111) will consider the expected benefit of wearing a BCI system for a given activity. For example, embodiment can recommend if activity A should be carried out while wearing a BCI system as a risk/reward analysis.

### Identifying Assignment Between Human and Robotic Worker

If the brain wave signal and AI enabled system identifies activities between human workers and robotic workers are to be reallocated, then an embodiment of the proposed system can utilize AR (Augmented reality) system to show the change in the assignment between the human worker and robotic workers. Traditional method of communication (e.g., printed page and/or spoken) can still be used but AR technology may provide advantages over those traditional medium of communication.

### Identifying Work Team Size and Allocation

While the activities are being performed, an embodiment of the proposed system can continue to compare the skilled and capabilities required to complete any activity with the aggregated capabilities between human workers and robotic workers in order to identify appropriate work allocation and team size. Thus, this core concept is a continuous and dynamic capability (e.g., machine learning, etc.) of the present embodiment that allows the system to perform achievements over time, i.e., CIP (continuous improvements).

### Determining Optimal Reallocation and Rescheduling Activities

An embodiment of the proposed system can analyze the current assigned activities and the respective brain wave signals/patterns of the human workers, and accordingly the embodiment can identify optimal reallocation and rescheduling the activities from human workers and robotic workers. Thus, this core concept is a continuous and dynamic capability (e.g., machine learning, etc.) of the present embodiment that allows the system to perform achievements over time, i.e., CIP (continuous improvements).

### How Embodiments(s) Implements Rules

An embodiment of the proposed system can have one or more rules to capture the BCI signals which are related to the current assigned activity or the brain waves which are related to the assigned activity. The rules are predetermined and configurable by the user.

One example is a classification rule. In an embodiment of the present invention, the embodiment can receive the acquired readings (e.g., BCI signals), etc.) and classify them accordingly. The purpose of the classification “rule” is to constrain the BCI system to preserve the privacy of the human worker when not performing the assigned activity. Thus, this classification rule is akin to an on/off switch.

In another embodiment, the one or more rules can leverage smart contract technology from blockchain. Recall that smart contracts are programs stored on blockchain that runs when a predetermined conditions are met (i.e., IF THEN statements in programming). For example, a smart contact rule to determine what type of brain waves should be collected from human users.

### Machine Learning/Algorithm

Activity component 111 can perform the above functionality or the six core capabilities through a machine learning process and/or as preprogrammed algorithms. Embodiments are agnostic to what type of machine learning process to use and can be determined and implemented based on the need of the user/admin.

Database 116 is a repository for data used by activity component 111. Database 116 can be implemented with any type of storage device capable of storing data and configuration files that can be accessed and utilized by server 110, such as a database server, a hard disk drive, or a flash memory. Database 116 uses one or more of a plurality of techniques known in the art to store a plurality of information. In the depicted embodiment, database 116 resides on server 110. In another embodiment, database 116 may reside elsewhere within activity environment 100, provided that activity component 111 has access to database 116. Database 116 may store information associated with, but is not limited to, knowledge corpus, historical data (e.g., brain waves, activities performed, result of activities performed, etc.) relating the human and robotic workers, digital twin simulation and scenarios, optimal brain wave pattern that meets or exceed certain quality criteria, brain wave pattern indicating that human workers may start to perform the task in an unsafe manner, best practices for managing robotic workers alongside human workers.

### Overall Process

A high-level process for FIG. 1 is explained further below. Human worker 102 is working alongside robotic worker 103 to perform some tasks and/or activity. The human worker 102 is wearing BCI 105 to monitor/measure the brain wave signal as the worker is performing various tasks. Embodiment of the present invention, through IoT 104 and network interface to BCI 105 is monitoring the brain activity of the human worker. As previously mentioned, there are at least six core capabilities of activity component 111. One aspect of an embodiment of activity component 111 allows for management of human and robotic workers to meet certain criteria as it related to the task/activities. For example, the criteria can include, but are not limited to, i) quality of work performed, ii) reduction in time, and iii) safety factors.

In other embodiments, activity component 111, may allow for running scenarios/simulations in a digital twin environment (setup to mirror the real-world situation) and identify skills and capabilities of human and/or robotic worker. For example, server 120 can be utilized to run digital twin simulations by activity component 111.

### Brain Interface

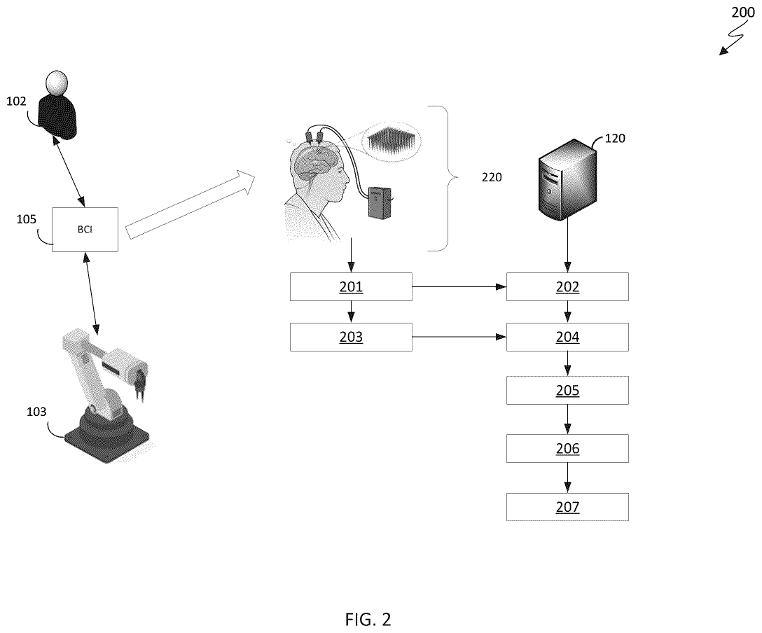

FIG. 2 is a diagram illustrating BCI between a human and robot, designated as 200, in accordance with an embodiment of the present invention. 200 includes, 102, 103, 105 and 120. In this scenario, the human and robotic worker are collaborating to complete an activity. One embodiment of activity component 111 can collect brain waves of the human worker to determine if any part of the activity should be reallocated to robotic should the quality of work performed by human worker falls below a certain threshold. This activity can be explained in detail by the process flow blocks (e.g., 201 through 206 of FIG. 2).

The process flow, of activity component 111, relates to the brain waves and other data are collected from the human workers (i.e., 220) and digital twin of the robotic workers residing on digital twin server 120. Referring to block 201 and block 202 of FIG. 2, block 201 denotes smart contract rules can be considered to identify which brain waves are to be used for analysis (by digital twin server 120) and block 203 denotes that other data to be feed into server can include requirements for activity specification on types of quality criteria.

Block 202 receives the brain waves that have been selected/determined by the smart contract rule and receives data from digital twin of the robotic workers (from server 120). Block 202 denotes identifying the aggregated skills and capabilities of human works and robotic workers. It is noted that any existing method of collection (e.g., non-invasive, etc.) of brain waves may be utilized. It is further noted that any existing methodology of processing brain wave signal may be utilized, including the use of BMI decoder.

Block 204 denotes the activity of identifying how human workers and robotic works can perform various activities and if the workers (e.g., human and robotic) can performed the activities based on a quality requirement/criteria.

Block 205 denotes the activity of determining whether any of the brain waves (collected from human workers) is not proper to complete the activity in a quality manner. It is noted that any existing method (e.g., machine learning, etc.) of analyzing brain waves may be utilized, wherein the characterization of brain activity can be performed through classification or through regression.

Block 206 denotes the activity of determining if additional robotic support is required by human workers to keep the aggregated human and robotic capability per requirement.

Block 207 denotes the activity of determining assignment. The choice of assignment may consist of, i) assigning appropriate robotic system along with the human worker, ii) rescheduling the activity and iii) reallocating the activity between human robotic systems.

### Skin Interface

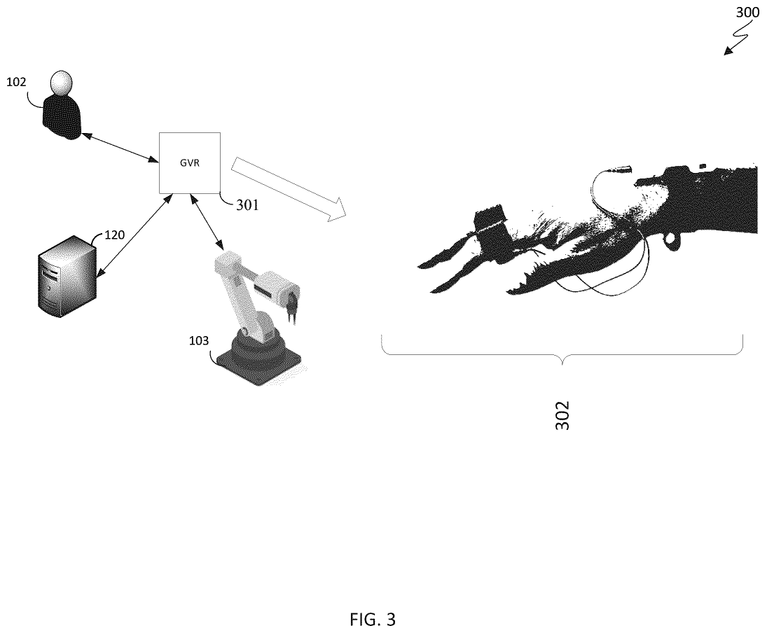

FIG. 3 is a simple diagram illustrating GVR (galvanic skin response) interface between a human and robot, designated as 300, in accordance with an embodiment of the present invention. 300 includes 102, 103, 120 and 302. GVR 301 denotes a system or module for converting electrical signals from the skin to be decoded by a decoder, similar to a BCI decoder. 302 illustrates an example of sensors on the human fingers that can collect physiological responses of the skin and encodes them as electrical signal to be passed through the BCI decoder (not pictured). It is noted that any existing method and/or technology for collecting galvanic response from the skin maybe utilized.

The high-level process flow after collecting the signal activity from the skin will be similar to block 201 to block 207 of FIG. 2. The only difference is that brain wave signals are not collected by GVR 301 but the body's electrical signal which can indicate the mental state and/or physiological state of the user.

### Process Flowchart

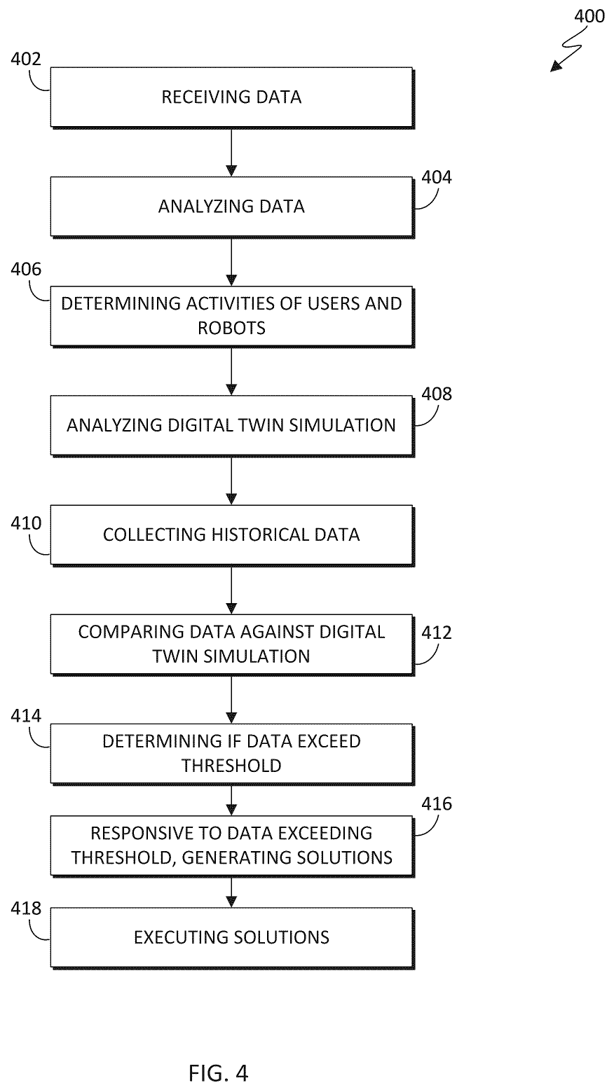

FIG. 4 is a high-level flowchart illustrating the operation of activity component 111, designated as 400, in accordance with an embodiment of the present invention. A use case scenario will be provided to illustrate the process flowchart. A factory for creating automobile parts employs human and robotic workers to assemble various parts. There is an assembly station (denoted as Station_1) to bolt the lower frame chassis to the main frame chassis. Station_1 has a mix of human and robotic workers that totals 8 workers. Stations_2 is an assembly station for installing interior parts which employs 4 human workers. Station_3 is an assembly station for welding safety parts to the chassis and employs 4 robotic workers to weld.

Activity component 111 receives data (step 402). In an embodiment, activity component 111, through BCI 105, collects brain waves data from a human worker. For example, referring to the use case scenario, activity component 111, collects brain wave activities from human workers at station_1 and station_2.

Activity component 111 analyzes data (step 404). In an embodiment, activity component 111, analyzes the brain data of the human workers. For example, referring to the use case scenario, activity component 111 analyzes the brain wave data from the human workers employed at station_1 and station_2. Any existing method can be utilized to analyze the brain waves after the BCI decoder.

Activity component 111 determines activities of human and robotic user (step 406). In an embodiment, activity component 111, through IoT 104, determines the activities being performed by human and robotic users. For example, referring to the use case scenario, activity component 111, through a camera device (IoT 104), can observe what type of activities the human and robotic workers are performing at station_1 to station_3. The camera can leverage object identification techniques in order to determine the activities being performed at each assembly stations.

Activity component 111 analyzes digital twin simulation (step 408). In an embodiment, activity component 111, through server 120, analyzes the robotic digital twin workers that resides in the digital twin simulation. A nearly exact replica of the physical environment is created on the digital twin server including the robotic workers. For example, referring to the use case scenario, station 1 through station 3 (along with the robotic workers assigned to those stations) are created as digital twin copies on server 120. The digital twin copies are “alive” (as simulations).

Activity component 111 collects historical data (step 410). In an embodiment, activity component 111, preserves current and historical data for future analysis. This data includes, but is not limited to, activities of human and robotic workers, brain waves of human workers and metrics (e.g., quality, time, etc.) of work performed by human workers.

Activity component 111 compares data against digital twin simulation (step 412). In an embodiment, activity component 111, compares the brain waves of human workers against the robotic workers from the digital twin simulation.

Recall that analysis and comparison between the human and robotic workers can determine the following, but it is not limited to: i) predict whether the human worker can complete the activity/task based on the required quality criteria, ii) prediction on whether the human worker can complete the activity based on the quality criteria, iii) prediction on whether robotic workers should assist the human worker to complete the activity (of human), iv) organizing and/or tracking skillset of human workers, v) reassigning human workers to another activity that is better suited based on their skillset, and vi) determining whether to combine both human and robotic workers to complete the activity/task.

In other embodiments, activity component 111 has the capabilities to, but not limited to: i) determining one or more skillsets and capabilities of the users and robotic counterpart to perform the activities based on the physiological data, ii) assigning new activities based on the one or more skillsets and capabilities to the users and robotic counterpart of the users, iii) aggregating the one or more skillsets and capabilities of the user and the robotic counterpart of the users, and iv) communicating to the users via augmented reality (AR) device.

Activity component 111 determines if brain data exceed threshold (step 414). In an embodiment, activity component 111, determines whether the brain waves of the human workers exceed a predetermined threshold (after the analysis from step 412). The predetermined threshold is a user configurable threshold that allows activity component 111 to make various decisions based on the analysis (see the previous steps on the list of analysis). For example, if a certain threshold of human workers at station_1 was met (indicating that human workers are becoming fatigued and eventually work performance/quality will suffer) then activity component 111 can generate possible solutions (see next step 416).

Activity component 111 generates possible solutions based on the brain data exceeding threshold (step 416). For example, referring to the use case scenario, human worker's performance at station_1 will suffer in the next 1-2 hours, activity component 11 can generate a list of possible solutions to mitigate the issue. One solution can include reassigning robotic workers (from another station or idle) to relieve the human workers at station_1 in an hour. Or the second solution, could include, scheduling an activity break for station_1.

Other generic solutions can include, but is not limited to: i) validates if the aggregated skills can be used for completing the activities, ii) determines that the aggregated capabilities will not be possible to complete the activities, then determines the reallocation of the activities, iii) identifies which steps of the activities of the users are to be reallocated to the robotic counterpart, and iv) identifies the activities to be allocated to any existing robotic counterpart or any new robotic counterpart can be allocated to perform the activities.

Activity component 111 executes a solution (step 418) that was proposed from step 416. For example, referring to the use case scenario, activity component 111 decides that it was optimal to reallocate robotic workers to replace the four human workers at station_1.

### Other Embodiments/Comments

Other embodiments of the present invention may include the following method, steps and/or systems:

In other embodiment, signal from the user can collected by combining GVR signal along with BCI (brain signal) in order to de-emphasize on reliance on solely on the BCI as a single source of truth.

In other embodiment, brain waves can be collected from non-human workers as well to perform the task/activities. For example, a dolphin can be trained to perform certain task in the water via BCI (waterproof version), such as, detecting and disarming water mines and sonar buoys. Furthermore, a robotic counterpart to a dolphin could be a marine drone (e.g., submarine style, etc.) with extendable appendages that can perform the same task. Thus, a digital twin simulation of the dolphin and the robotic counterpart can be used to, practice the task in the digital world and test out in the real work. The activities and brain waves of the dolphin can be collected and analyzed to determine how best to perform the activity.

Alternatively, the proposed concept/steps/methods and systems may be summarized in a nutshell in the following clauses:
In any industrial floor, or any in activity surrounding where various criticality is present, and any change in human level of confidence, or identifying appropriate way of performing the activity is important.
The proposed system will be having any defined quality criteria, like time to complete any activity, precision in the work product, safety factors etc. are the criteria of the work product or activity.
The proposed system will be having a historically created knowledge corpus about the quality of the activities and the brain wave signals from the workers while performing the activities.
The proposed system will also be performing digital twin simulation of the robotic workers to identify the skills, capabilities etc.
Each and every activity will be identified with its required capabilities, skills, various steps of the activities.
Based on historical learning, the proposed system will be identifying what will be the required skills and capabilities required to perform the activities and associated brain wave signals.
The proposed system will be using the historically captured data to identify which brain wave signals are creating better quality of the activities and which types of brain wave reduces its capabilities.
The proposed system will be identifying each and every robotic systems and their respective capabilities to perform the activities.
Based on historical learning, the proposed system will be assigning the activities to human workers and robotic workers to leverage best skills.
Each and every activity will be segmented with various steps and how different steps are requiring different capabilities and skills.
The proposed system will be having a rule to capture the BCI signals which are related to the current assigned activity or the brain waves which are related to the assigned activity.
The proposed system will be using historical learning to identify which brain wave are to be selected, and the proposed system can use smart contract rule.
While human workers and robotic workers are collaborating to perform any activity, then proposed system will be capturing the brain wave from the workers.
The proposed system will be considering the brain wave and the historically created knowledge corpus to find workers capabilities, skills, confidence in the activity.
The proposed system will be aggregating the human workers skills and the robotic workers skills.
The proposed system will be validating if the aggregated skills can be used for completing the activities.
If the proposed system identifies, the aggregated capabilities will not be possible to complete the activity, then the proposed system will be evaluating the reallocation of the activities.
The proposed system will be identifying which steps of the human workers activities are to be reallocated to robotic workers.
The proposed system will be communicating the same with the user worker with augmented reality (AR) or with voice interaction.
The identified activities will be allocated to any existing robotic system or any new robotic system will be allocated to perform the activity.

### Hardware Environment

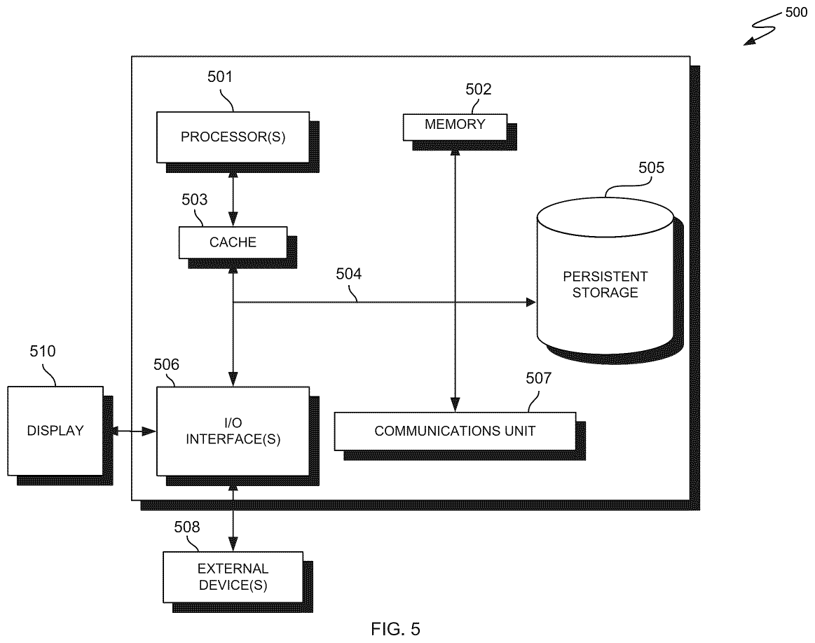

FIG. 5 depicts a block diagram, designated as 500 of components of a server computer capable of executing the activity component 111 within activity environment 100, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

It is to be understood that embodiments of the present invention may be executed inside a cloud-computing infrastructure and is not limited to network servers.

FIG. 5 includes processor(s) 501, cache 503, memory 502, persistent storage 505, communications unit 507, input/output (I/O) interface(s) 506, and communications fabric 504. Communications fabric 504 provides communications between cache 503, memory 502, persistent storage 505, communications unit 507, and input/output (I/O) interface(s) 506. Communications fabric 504 can be implemented with any architecture designed for passing data and/or control information between processors (such as microprocessors, communications and network processors, etc.), system memory, peripheral devices, and any other hardware components within a system. For example, communications fabric 504 can be implemented with one or more buses or a crossbar switch.

Memory 502 and persistent storage 505 are computer readable storage media. In this embodiment, memory 502 includes random access memory (RAM). In general, memory 502 can include any suitable volatile or non-volatile computer readable storage media. Cache 503 is a fast memory that enhances the performance of processor(s) 501 by holding recently accessed data, and data near recently accessed data, from memory 502.

Program instructions and data (e.g., software and data ×10) used to practice embodiments of the present invention may be stored in persistent storage 505 and in memory 502 for execution by one or more of the respective processor(s) 501 via cache 503. In an embodiment, persistent storage 505 includes a magnetic hard disk drive. Alternatively, or in addition to a magnetic hard disk drive, persistent storage 505 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 505 may also be removable. For example, a removable hard drive may be used for persistent storage 505. Other examples include optical and magnetic disks, thumb drives, and smart cards that are inserted into a drive for transfer onto another computer readable storage medium that is also part of persistent storage 505. Activity component 111 can be stored in persistent storage 505 for access and/or execution by one or more of the respective processor(s) 501 via cache 503.

Communications unit 507, in these examples, provides for communications with other data processing systems or devices. In these examples, communications unit 507 includes one or more network interface cards. Communications unit 507 may provide communications through the use of either or both physical and wireless communications links. Program instructions and data (e.g., activity component 111) used to practice embodiments of the present invention may be downloaded to persistent storage 505 through communications unit 507.

I/O interface(s) 506 allows for input and output of data with other devices that may be connected to each computer system. For example, I/O interface(s) 506 may provide a connection to external device(s) 508, such as a keyboard, a keypad, a touch screen, and/or some other suitable input device. External device(s) 508 can also include portable computer readable storage media, such as, for example, thumb drives, portable optical or magnetic disks, and memory cards. Program instructions and data (e.g., activity component 111) used to practice embodiments of the present invention can be stored on such portable computer readable storage media and can be loaded onto persistent storage 505 via I/O interface(s) 506. I/O interface(s) 506 also connects to display 510.

Display 510 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for managing activities of users and robotic counterpart of the users, the computer-implemented method comprising:
receiving data from the users;
analyzing the data from the users;
determining activities of the users and the robotic counterpart of the users;
analyzing a digital twin simulation of based on the activities of the users and robotic counterpart;
collecting a first historical data of the activities of the users and the robotic counterpart and a second historical data from the digital twin simulation;
comparing the data against the digital twin simulation by evaluating work criteria;
determining whether the data exceeds a predetermined threshold of the work criteria;
in responsive to the data exceeds the predetermined threshold, generating one or more solutions in order to improve the work criteria of the users and/or the robotic counterpart; and
executing the one or more solutions with new instructions to the user and/or the robotic counterpart.

2. The computer-implemented method of claim 1, wherein the data is physiological data from the user consisting of brain waves and/or skin response.

3. The computer-implemented method of claim 2, further comprising:
determining one or more skillsets and capabilities of the users and robotic counterpart to perform the activities based on the physiological data;
assigning new activities based on the one or more skillsets and capabilities to the users and robotic counterpart of the users;
aggregating the one or more skillsets and capabilities of the user and the robotic counterpart of the users; and
communicating to the users via augmented reality (AR) device.

4. The computer-implemented method of claim 3, wherein the digital twin simulation comprises of: i) predicting whether the users can complete the activities based on a required quality criteria, ii) predicting whether the users can complete the activities based on the required quality criteria, iii) predicting whether robotic counterpart should assist the user to complete the activities (of the user), iv) organizing and/or tracking the one or more skillsets and capabilities of the users, v) reassigning users to another activity that is better suited based on the one or more skillsets and capabilities of the users, and vi) determining whether to combine both the users and the robotic counterpart to complete the activities (current).

5. The computer-implemented method of claim 1, wherein the predetermined threshold is user configurable.

6. The computer-implemented method of claim 1, wherein comparing the data against the digital twin simulation based on the work criteria wherein work criteria includes efficiency, quality, and cost, further comprising:
determining whether the users can complete the activities within an allotted timeframe;
determining whether the users can complete the activities within an allotted cost; and
determining whether the users can complete the activities without sacrificing quality and safety.

7. The computer-implemented method of claim 1, wherein the one or more solutions further comprises: i) validates if an aggregated skills and capabilities from the one or more skills and capabilities can be used for completing the activities, ii) determines that the aggregated capabilities and capabilities will not be possible to complete the activities, then determines reallocation of the activities, iii) identifies which steps of the activities of the users are to be reallocated to the robotic counterpart, and iv) identifies the activities to be allocated to any existing robotic counterpart or any new robotic counterpart can be allocated to perform the activities.

8. A computer program product for managing activities of users and robotic counterpart of the users, the computer program product comprising:
one or more computer-readable storage media having computer-readable program instructions stored on the one or more computer-readable storage media said program instructions executes a computer-implemented method comprising the steps of:
receiving data from the users;
analyzing the data from the users;
determining activities of the users and the robotic counterpart of the users;
analyzing a digital twin simulation of based on the activities of the users and robotic counterpart;
collecting a first historical data of the activities of the users and the robotic counterpart and a second historical data from the digital twin simulation;
comparing the data against the digital twin simulation by evaluating work criteria;
determining whether the data exceeds a predetermined threshold of the work criteria;
in responsive to the data exceeds the predetermined threshold, generating one or more solutions in order to improve the work criteria of the users and/or the robotic counterpart; and
executing the one or more solutions with new instructions to the user and/or the robotic counterpart.

9. The computer program product of claim 8, wherein the data is physiological data from the user consisting of brain waves and/or skin response.

10. The computer program product of claim 9, further comprising:
determining one or more skillsets and capabilities of the users and robotic counterpart to perform the activities based on the physiological data;
assigning new activities based on the one or more skillsets and capabilities to the users and robotic counterpart of the users;
aggregating the one or more skillsets and capabilities of the user and the robotic counterpart of the users; and
communicating to the users via augmented reality (AR) device.

11. The computer program product of claim 10, wherein the digital twin simulation comprises of: i) predicting whether the users can complete the activities based on a required quality criteria, ii) predicting whether the users can complete the activities based on the required quality criteria, iii) predicting whether robotic counterpart should assist the user to complete the activities (of the user), iv) organizing and/or tracking the one or more skillsets and capabilities of the users, v) reassigning users to another activity that is better suited based on the one or more skillsets and capabilities of the users, and vi) determining whether to combine both the users and the robotic counterpart to complete the activities (current).

12. The computer program product of claim 8, wherein the predetermined threshold is user configurable.

13. The computer program product of claim 8, wherein comparing the data against the digital twin simulation based on the work criteria wherein the work criteria includes efficiency, quality, and cost, further comprising:
determining whether the users can complete the activities within an allotted timeframe;
determining whether the users can complete the activities within an allotted cost; and
determining whether the users can complete the activities without sacrificing quality and safety.

14. The computer program product of claim 8, wherein the one or more solutions further comprises: i) validates if an aggregated skills and capabilities from the one or more skills and capabilities can be used for completing the activities, ii) determines that the aggregated capabilities and capabilities will not be possible to complete the activities, then determines reallocation of the activities, iii) identifies which steps of the activities of the users are to be reallocated to the robotic counterpart, and iv) identifies the activities to be allocated to any existing robotic counterpart or any new robotic counterpart can be allocated to perform the activities.

15. A computer system for managing activities of users and robotic counterpart of the users, the computer system comprising:
one or more computer processors; and
one or more computer readable storage media having computer-readable program instructions stored on the one or more computer readable storage media, said program instructions executes, by the one or more computer processors, a computer-implemented method comprising the steps of:
receiving data from the users;
analyzing the data from the users;
determining activities of the users and the robotic counterpart of the users;
analyzing a digital twin simulation of based on the activities of the users and robotic counterpart;
collecting a first historical data of the activities of the users and the robotic counterpart and a second historical data from the digital twin simulation;
comparing the data against the digital twin simulation by evaluating work criteria;
determining whether the data exceeds a predetermined threshold of the work criteria;
in responsive to the data exceeds the predetermined threshold, generating one or more solutions in order to improve the work criteria of the users and/or the robotic counterpart; and
executing the one or more solutions with new instructions to the user and/or the robotic counterpart.

16. The computer system of claim 15, wherein the data is physiological data from the user consisting of brain waves and/or skin response further comprising:
determining one or more skillsets and capabilities of the users and robotic counterpart to perform the activities based on the physiological data;
assigning new activities based on the one or more skillsets and capabilities to the users and robotic counterpart of the users;
aggregating the one or more skillsets and capabilities of the user and the robotic counterpart of the users; and
communicating to the users via augmented reality (AR) device.

17. The computer system of claim 15, wherein the digital twin simulation comprises of: i) predicting whether the users can complete the activities based on a required quality criteria, ii) predicting whether the users can complete the activities based on the required quality criteria, iii) predicting whether robotic counterpart should assist the user to complete the activities (of the user), iv) organizing and/or tracking the one or more skillsets and capabilities of the users, v) reassigning users to another activity that is better suited based on the one or more skillsets and capabilities of the users, and vi) determining whether to combine both the users and the robotic counterpart to complete the activities (current).

18. The computer system of claim 15, wherein the predetermined threshold is user configurable.

19. The computer system of claim 15, wherein comparing the data against the digital twin simulation based on the work criteria wherein work criteria includes efficiency, quality, and cost, further comprising:
determining whether the users can complete the activities within an allotted timeframe;
determining whether the users can complete the activities within an allotted cost; and
determining whether the users can complete the activities without sacrificing quality and safety.

20. The computer system of claim 15, wherein the one or more solutions further comprises: i) validates if the aggregated skills can be used for completing the activities, ii) determines that the aggregated capabilities will not be possible to complete the activities, then determines the reallocation of the activities, iii) identifies which steps of the activities of the users are to be reallocated to the robotic counterpart, and iv) identifies the activities to be allocated to any existing robotic counterpart or any new robotic counterpart can be allocated to perform the activities.
